(19) United States
(12) Patent Application Publication
(10) Pub. No.: US 2024/0014379 A1
(43) Pub. Date: Jan. 11, 2024

(54) Cathode with Improved Structural Stability for Lithium Secondary Battery, Method for Manufacturing Same, and Lithium Secondary Battery Comprising Same

(71) Applicant: LG Energy Solution, Ltd., Seoul (KR)

(72) Inventors: Gwang Yeon Kim, Daejeon (KR); Sang Seung Oh, Daejeon (KR); Hye Hyeon Kim, Daejeon (KR); Chi Ho Jo, Daejeon (KR)

(73) Assignee: LG Energy Solution, Ltd., Seoul (KR)

(21) Appl. No.: 18/025,580

(22) PCT Filed: May 6, 2022
(86) PCT No.: PCT/KR2022/006464

§ 371 Date: Mar. 9, 2023

(30) Foreign Application Priority Data
Jun. 2, 2021 (KR) 10-2021-0071223

(51) Int. Cl. H01M 4/1391; H01M 4/505; H01M 4/525; H01M 4/04; H01M 10/0525; H01M 4/36

(52) U.S. Cl. CPC H01M 4/1391; H01M 4/505; H01M 4/525; H01M 4/0435; H01M 10/0525; H01M 4/364; H01M 4/366; H01M 2004/028

(57) ABSTRACT

Provided is a positive electrode for a lithium secondary battery with improved structural stability, a manufacturing method thereof, and a lithium secondary battery including the same. When the positive electrode containing a positive electrode additive is manufactured, the conditions of first and second rolling operations are controlled so that there is an advantage in that structures and electrical properties of a first mixture layer and a second mixture layer can be improved.

### CROSS-REFERENCE TO RELATED APPLICATIONS

This application is a national phase entry under 35 U.S.C. § 371 of International Application No. PCT/KR2022/006464, filed on May 6, 2022, which claims priority from Korean Patent Application No. 10-2021-0071223, filed on Jun. 2, 2021, the disclosures of which are incorporated by reference herein.

### TECHNICAL FIELD

The present disclosure relates to a positive electrode for a lithium secondary battery with improved structural stability, a manufacturing method thereof, and a lithium secondary battery including the same.

### BACKGROUND ART

Recently, the demand for secondary batteries as energy sources is rapidly increasing.

Among these secondary batteries, a lithium secondary battery having a high energy density and a high voltage, a long cycle life, and a low self-discharge rate has been commercialized and widely used.

Graphite is mainly used as a negative electrode material of the lithium secondary battery. However, since the graphite has a small capacity per unit mass of 372 mAh/g, it is difficult to achieve a high capacity of the lithium secondary battery. Accordingly, in order to achieve the high capacity of the lithium secondary battery, as a non-carbon-based negative electrode material having a higher energy density than the graphite, a negative electrode material forming an intermetallic compound with lithium, such as silicon, tin, and an oxide thereof, has been developed and used. However, such a non-carbon-based negative electrode material has a problem in that, although a capacity is large, initial efficiency is low and thus lithium consumption is great during an initial charging and discharging and loss of an irreversible capacity is large.

In this regard, a method capable of providing a lithium ion source or reservoir for a positive electrode material and overcoming irreversible capacity loss of a negative electrode using a material that is electrochemically active after a first cycle so as not to degrade the overall performance of the battery has been proposed. Specifically, a method of applying an oxide containing an excess of lithium, for example, Li₆CoO₄, to the positive electrode as a sacrificial positive electrode material or an irreversible additive (or an overdischarge inhibitor) is known.

Meanwhile, an existing irreversible additive such as Li₆CoO₄ is generally prepared by reacting cobalt oxide or the like with an excess of lithium oxide. The irreversible additive prepared as described above is structurally unstable and generates a large amount of oxygen gas (O₂) as charging is performed as follows. When the secondary battery is initially charged, that is, when all of the irreversible additive has not reacted and remains upon activation of the battery, a reaction may occur in the subsequent charging/discharging process to cause a side reaction or a large amount of oxygen gas inside the battery. The generated oxygen gas may cause volume expansion of an electrode assembly and act as one of the main factors causing degradation of battery performance.

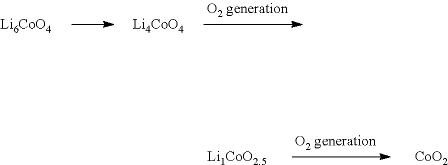

In addition, the conventionally used irreversible additive exhibits a very low powder electrical conductivity of ˜10⁻¹¹ S/cm, which is close to an insulator, due to a two-dimensional (2D) percolating network. The low powder electrical conductivity increases electrical resistance of the positive electrode. In this case, a large capacity of 200 mAh/g or more is exhibited at a low C-rate, and when the C-rate is increased, since performance is rapidly decreased as charging and discharging proceed due to large resistance, there is a limitation in that a charging/discharging capacity of the battery is decreased, and high-speed charging and high-speed discharging are difficult.

Accordingly, there is a demand for the development of a lithium secondary battery with excellent electrical performance and improved battery safety.

### RELATED ART DOCUMENT

### Patent Document

Japanese Patent Laid-open Application No. 2019-061751

### DISCLOSURE

### Technical Problem

An object of the present technology is to provide a positive electrode for a lithium secondary battery with improved electrical performance and improved structural stability, a manufacturing method thereof, and a lithium secondary battery including the same.

### Technical Solution

The present technology is directed to providing a positive electrode for a lithium secondary battery including a current collector and a mixture layer formed on one surface or both surfaces of the current collector, wherein the mixture layer is a double-layer structure in which a first mixture layer and a second mixture layer are stacked. The first mixture layer includes a positive electrode active material, a positive electrode additive represented by Chemical Formula 1 below, a conductive material, and a binder. The porosity of the first mixture layer ranges from 15 to 40%, and the porosity of the second mixture layer ranges from 40 to 70%.

LiₚCo_{(1-q)}M¹_{q}O₄ [Chemical Formula 1]

In Chemical Formula 1, M¹ denotes at least one element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and p and q are 5≤p≤7 and 0≤q≤0.5, respectively.

An average thickness of the first mixture layer may range from 0.1 μm to 20 μm, and an average thickness of the second mixture layer may range from 50 μm to 300 μm.

A ratio (D1:D2) of an average thickness (D1) of the first mixture layer to an average thickness (D2) of the second mixture layer may range from 4:6 to 1:10.

A content of the positive electrode additive may range from 0.1 to 5 wt % based on a total weight of the first mixture layer.

The positive electrode active material may be a lithium nickel composite oxide represented by Chemical Formula 2 below.

Liₓ[Ni_{y}Co_{z}Mn_{w}M²ᵥ]Oᵤ [Chemical Formula 2]

In Chemical Formula 2, M² denotes at least one element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and x, y, z, w, v, and u are 1.0≤x≤1.30, 0.1≤y<0.95, 0.01<z≤0.5, 0.01<w≤0.5, 0≤v≤0.2, and 1.5≤u≤4.5, respectively.

The present technology is also directed to providing a method of manufacturing a positive electrode for a lithium secondary battery according to the present technology including forming a first mixture layer in a first mixture layer forming operation by applying a first slurry including a positive electrode active material and the positive electrode additive represented by Chemical Formula 1 on one side or both sides of a current collector, rolling the formed first mixture layer in a first rolling operation, forming a second mixture layer in a second mixture layer forming operation by applying second slurry including a positive electrode active material on the rolled first mixture layer, and rolling the formed second mixture layer in a second rolling operation, wherein the porosity of the first mixture layer ranges from 15% to 40%, and the porosity of the second mixture layer ranges from 40% to 70%.

LiₚCo_{(1-q)}M¹_{q}O₄ [Chemical Formula 1]

In Chemical Formula 1, M¹ denotes at least one element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and p and q are 5≤p≤7 and 0≤q≤0.5, respectively.

The first rolling operation may be performed at a speed ranging from 0.5 m/s to 6 m/s, the second rolling operation may be performed at a speed ranging from 2 m/s to 7 m/s, and the second rolling operation may be performed at a faster speed than the first rolling operation.

The first rolling operation may be performed at a temperature ranging from 10° C. to 40° C., and the second rolling operation may be performed at a temperature ranging from 40° C. to 100° C.

The first mixture layer may satisfy a thickness change rate condition of Equation 1 below.

D²ₘᵢₙ/D¹ₘₐₓ×100≥70% [Equation 1]

In Equation 1, D¹ₘₐₓ may denote a maximum thickness of the first mixture layer after the first rolling operation, and D²ₘᵢₙ may denote a minimum thickness of the first mixture layer after the second rolling operation.

The present technology is also directed to providing a lithium secondary battery including the above-described positive electrode according to the present technology, a negative electrode, and a separator interposed between the positive electrode and the negative electrode.

The negative electrode may include a negative electrode current collector and a negative electrode mixture layer which is located on the negative electrode current collector and contains a negative electrode active material, and the negative electrode active material may include a carbon material and a silicon material.

### Advantageous Effects

A positive electrode for a lithium secondary battery according to the present technology, a manufacturing method thereof, and a lithium secondary battery including the same have an advantage in that, when the positive electrode containing a positive electrode additive is manufactured, the conditions of first and second rolling operations are controlled, and thus structures and electrical properties of a first mixture layer and a second mixture layer can be improved.

### DETAILED DESCRIPTION

The present invention may be modified into various forms and may have a variety of embodiments, and therefore, specific embodiments will be described in detail.

The embodiments, however, are not to be taken in a sense which limits the present invention to the specific embodiments and should be construed to include modifications, equivalents, or substituents within the spirit and technical scope of the present invention.

In the present disclosure, the terms “comprising,” “having,” and the like are used to specify that the presence of a feature, a number, a step, an operation, a component, an element, or a combination thereof described herein, and they do not preclude the presence or addition of one or more other features, numbers, steps, operations, components, elements, or combinations thereof.

In addition, in the present disclosure, when a portion of a layer, a film, a region, a plate, or the like is described as being “on” another portion, this includes not only a case in which the portion is “directly on” another portion but also a case in which still another portion is present between the portion and another portion. Conversely, when a portion of a layer, a film, a region, a plate, or the like is described as being “under” another portion, this includes not only a case in which the portion is “directly under” another portion but also a case in which still another portion is present between the portion and another portion. In addition, in this application, as being disposed “on” may include the case of being disposed not only on an upper portion but also on a lower portion.

Hereinafter, the present invention will be described in more detail.

Positive Electrode for Lithium Secondary Battery

In one embodiment of the present technology, there is provided a positive electrode for a lithium secondary battery, which includes a current collector and a mixture layer formed on one surface or both surfaces of the current collector, wherein the mixture layer is a double-layer structure in which a first mixture layer and a second mixture layer are stacked. The first mixture layer includes a positive electrode active material, a positive electrode additive represented by Chemical Formula 1 below, a conductive material, and a binder. The porosity of the first mixture layer ranges from 15% to 40%, and the porosity of the second mixture layer ranges from 40% to 70%.

LiₚCo_{(1-q)}M¹_{q}O₄ [Chemical Formula 1]

In Chemical Formula 1, M¹ denotes at least one element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and p and q are 5≤p≤7 and 0≤q≤0.5, respectively.

Specifically, in Chemical Formula 1, M¹ may denote a Zn element, and q may be 0.2≤q≤0.4.

The positive electrode for a lithium secondary battery according to the present technology has a double-layer structure in which the first mixture layer and the second mixture layer are sequentially stacked on the current collector and has a structure in which the second mixture layer is located at the outermost portion. In particular, the positive electrode for a lithium secondary battery according to the present technology may improve structures and electrical properties of the first and second mixture layers by controlling the conditions of first and second rolling processes when the positive electrode is manufactured.

The positive electrode additive may contain lithium (Li) in excess and may provide Li for lithium consumption generated by an irreversible chemical and physical reaction at the negative electrode during initial charging, and thus a charging capacity of the battery is increased and the irreversible capacity is reduced so that lifetime characteristics can be improved.

According to the present technology, a lithium cobalt oxide represented by Chemical Formula 1 may be employed as the positive electrode additive. In this case, as the lithium cobalt oxide represented by Chemical Formula 1, Li₆CoO₄, Li₆Co_{0.5}Zn_{0.5}O₄, and Li₆Co_{0.7}Zn_{0.3}O₄ alone or a combination thereof may be used. When compared to nickel-containing oxides commonly used in the art, the lithium cobalt oxide represented by Chemical Formula 1 has an advantage in that, since a content of lithium ions is high and a voltage range required for delithiation is low, lithium ions may be desorbed without affecting a reaction of the positive electrode active material when the battery is activated.

In addition, the lithium cobalt metal oxide represented by Chemical Formula 1 may have a tetragonal crystal structure and have a space group of P4₂/nmc among the tetragonal crystal structures. The lithium cobalt metal oxide represented by Chemical Formula 1 exhibits excellent charging/discharging characteristics and lifetime characteristics in the lithium secondary battery but has a problem in that thermal stability is low. Specifically, when the lithium cobalt metal oxide represented by Chemical Formula 1 is used as a positive electrode additive, structural deformation occurs due to an influence of temperature during preparation of the mixture layer of the positive electrode, for example, a temperature of the slurry, so that battery characteristics may be degraded.

Thus, the positive electrode for a lithium secondary battery according to the present technology prevents structural deformation of the positive electrode additive from occurring and improves the structures and the electrical properties of the first and second mixture layers by controlling the conditions of the first and second rolling processes when the positive electrode containing the positive electrode additive is manufactured.

As an example, the positive electrode for a lithium secondary battery according to the present technology may satisfy Equation 1 below during X-ray diffraction (XRD) analysis of the first mixture layer.

A/B≤1 [Equation 1]

A denotes an intensity of the strongest peak among peaks shown in the range of 2θ=38.5±0.1°, and B denotes an intensity of the strongest peak among peaks shown in the range of 2θ=47.9±0.1°.

In Equation 1, the peak B shown in the range of 2θ=47.9±0.1° is implemented by a crystal of the lithium cobalt metal oxide represented by Chemical Formula 1, and the peak A shown in the range of 2θ=38.5±0.1° is implemented by an impurity. It means that a fraction of the lithium cobalt metal oxide represented by Chemical Formula 1 increases as an intensity ratio of the peaks, that is, “A/B,” decreases. In the positive electrode according to the present technology, the fraction of the lithium cobalt metal oxide represented by Chemical Formula 1 of the positive electrode additive included in the first mixture layer is improved to 98% or more so that A/B may satisfy 1 or less, 0.35 or less, 0.25 or less, or 0.1 or less. In some cases, since the lithium cobalt metal oxide represented by Formula 1 accounts for a 100% fraction of the positive electrode additive, A/B may satisfy zero.

In addition, the porosity of the first mixture layer may range from 15% to 40%, and specifically, from 20% to 40%, from 20% to 35%, from 25% to 40%, from 25% to 35%, or from 25% to 30%.

When the porosity of the first mixture layer is too small, it may be difficult for the electrolyte to penetrate to a surface of the current collector, whereas, when the porosity is too large, a density of the electrode is lowered and thus an amount of an active material in contact with the current collector may be reduced so that degradation of capacity and output may occur. Accordingly, the porosity of the first mixture layer may be in the above-described range.

The measurement of the porosity is not particularly limited, and in one embodiment of the present technology, the porosity may be measured by, for example, a Brunauer-Emmett-Teller (BET) measurement method or a mercury (Hg) porosimeter.

In addition, a content of the positive electrode additive may range from 0.1 to 5 parts by weight based on 100 parts by weight of the first mixture layer, and specifically, from 0.1 to 3 parts by weight or from 1 to 3 parts by weight.

The first mixture layer is a positive electrode active material capable of reversible intercalation and deintercalation and may include a lithium nickel composite oxide represented by Chemical Formula 2 below.

Liₓ[Ni_{y}Co_{z}Mn_{w}M²ᵥ]Oᵤ [Chemical Formula 2]

In Chemical Formula 2, M² denotes at least one element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and x, y, z, w, v, and u are 1.0≤x≤1.30, 0.1≤y<0.95, 0.01<z≤0.5, 0.01<w≤0.5, 0≤v≤0.2, and 1.5≤u≤4.5, respectively.

The lithium nickel composite oxide represented by Chemical Formula 2 is a composite metal oxide including Li, nickel, cobalt, and manganese, and in some cases, may have a form in which another transition metal (M²) is doped. For example, the positive electrode active material may include one or more compounds selected from the group consisting of LiNi_{1/3}Co_{1,3}Mn_{1/3}O₂, LiNi_{0.6}Co_{0.2}Mn_{0.2}O₂, LiNi_{0.5}Co_{0.1}Mn_{0.1}O₂, LiNi_{0.9}Co_{0.05}Mn_{0.05}O₂, LiNi_{0.8}Co_{0.1}Mn_{0.05}Al_{0.05}O₂, and LiNi_{0.7}Co_{0.1}Mn_{0.1}Al_{0.1}O₂. As an example, in the positive electrode active material, LiNi_{0.6}Co_{0.2}Mn_{0.2}O₂, and LiNi_{0.8}Co_{0.1}Mn_{0.1}O₂ may be used alone or in combination as the lithium nickel composite metal oxide represented by Chemical Formula 2.

In addition, a content of the positive electrode active material may range from 85 to 95 parts by weight based on 100 parts by weight of the first mixture layer, and specifically, from 88 to 95 parts by weight, from 90 to 95 parts by weight, from 86 to 90 parts by weight, or from 92 to 95 parts by weight.

In this case, the conductive material may be used to improve the performance of the positive electrode, such as conductivity, and one or more selected from the group consisting of natural graphite, artificial graphite, carbon black, acetylene black, Ketjen black, and carbon fiber may be used as the conductive material. For example, the conductive material may include acetylene black.

In addition, the conductive material may be included in an amount of 1 to 10 parts by weight based on 100 parts by weight of the first mixture layer, and specifically, in an amount of 2 to 8 parts by weight or 2 to 6 parts by weight.

In addition, the binder may include one or more resins selected from the group consisting of a polyvinylidene fluoride-hexafluoropropylene copolymer (PVDF-co-HFP), polyvinylidene fluoride, polyacrylonitrile, polymethylmethacrylate, and a copolymer thereof. As an example, the binder may include polyvinylidene fluoride.

In addition, the binder may be included in an amount of 1 to 10 parts by weight based on 100 parts by weight of the first mixture layer, and specifically, may be included in an amount of 2 to 8 parts by weight or 2 to 6 parts by weight.

In addition, an average thickness of the first mixture layer is not particularly limited, but specifically, may range from 0.1 μm to 20 μm, and more specifically, from 0.1 μm to 15 μm, from 0.1 μm to 10 μm, from 2 μm to 10 μm, from 4 μm to 10 μm, or from 5 μm to 9 μm.

In addition, the second mixture layer is formed on the first mixture layer formed on the current collector, includes a positive electrode active material, and may further include the conductive material and the binder together with the positive electrode active material, as necessary.

In addition, the porosity of the second mixture layer may range from 40% to 70%, and specifically, from 40% to 65%, from 40% to 60%, from 45% to 60%, from 45% to 55%, or from 45% to 50%. In particular, the second mixture layer located on the outermost side of the positive electrode may increase the electrolyte impregnation property into the electrode by increasing the porosity. Thus, an energy density is increased so that the capacity, output characteristics, and a charging/discharging speed of the secondary battery including the positive electrode can be improved.

On the other hand, the first mixture layer and the second mixture layer, which are described above, may be separately applied and rolled, thereby having a porosity difference and forming an interface without being mixed with each other.

The positive electrode active material included in the second mixture layer may be applied without particular limitation as long as it is a lithium metal composite oxide represented by Chemical Formula 2, and the positive electrode active material may include one or more compounds selected from the group consisting of LiNi_{1/3}Co_{1,3}Mn_{1/3}O₂, LiNi_{0.6}Co_{0.2}Mn_{0.2}O₂, LiNi_{0.8}Co_{0.1}Mn_{0.1}O₂, LiNi_{0.9}Co_{0.05}Mn_{0.05}O₂, LiNi_{0.8}Co_{0.1}Mn_{0.05}Al_{0.05}O₂, and LiNi_{0.7}Co_{0.1}Mn_{0.1}Al_{0.1}O₂.

As an example, the positive electrode active material may be a lithium nickel composite metal oxide represented by Chemical Formula 2 and LiNi_{0.6}Co_{0.2}Mn_{0.2}O₂, and LiNi_{0.8}Co_{0.1}Mn_{0.1}O₂ alone or a combination thereof may be used as the positive electrode active material.

In addition, a content of the positive electrode active material may be 80 to 98 parts by weight based on 100 parts by weight of the second mixture layer, and specifically, may be 84 to 96 parts by weight or 88 to 96 parts by weight.

In this case, the conductive material included in the second mixture layer may be used to improve the performance of the positive electrode, such as conductivity, and one or more selected from the group consisting of natural graphite, artificial graphite, carbon black, acetylene black, Ketjen black, and carbon fiber may be used as the conductive material. For example, the conductive material may include acetylene black.

In addition, the conductive material may be included in an amount of 1 to 10 parts by weight based on 100 parts by weight of the second mixture layer, and specifically, in an amount of 2 to 8 parts by weight or 2 to 6 parts by weight.

In addition, the binder included in the second mixture layer may include one or more resins selected from the group consisting of PVDF-co-HFP, polyvinylidene fluoride, polyacrylonitrile, polymethylmethacrylate, and a copolymer thereof. As an example, the binder may include polyvinylidene fluoride.

In addition, the binder may be included in an amount of 1 to 10 parts by weight based on 100 parts by weight of the second mixture layer, and specifically, in an amount of 2 to 8 parts by weight or 2 to 6 parts by weight.

In addition, an average thickness of the second mixture layer may range from 50 μm to 300 μm, and specifically, from 100 μm to 200 μm, from 80 μm to 150 μm, from 120 μm to 170 μm, from 150 μm to 300 μm, from 200 μm to 300 μm, or from 150 μm to 190 μm.

In a specific example, a thickness of the second mixture layer may be greater than a thickness of the first mixture layer.

In addition, a ratio (D1:D2) of an average thickness (D1) of the first mixture layer to an average thickness (D2) of the second mixture layer may range from 4:6 to 1:10. Specifically, the average thickness ratio (D1:D2) between the first and second positive electrode mixture layers may range from 3:7 to 1:10 or from 2:8 to 1:9. In the present technology, the thickness of the second negative electrode mixture layer is formed to be relatively thick so that a bonding force with the current collector is increased and stability of the electrode is increased.

Meanwhile, in the positive electrode for a lithium secondary battery according to the present technology, a material having high conductivity without causing a chemical change in the battery may be used as the current collector. For example, stainless steel, aluminum, Ni, titanium, and calcined carbon may be used, and aluminum or stainless steel, one whose surface is treated with carbon, Ni, titanium, and silver may be used as the current collector. In addition, fine irregularities may be formed on a surface of the current collector to enhance a bonding force of the positive electrode active material, and a positive electrode current collector in various forms such as a film, a sheet, a foil, a net, a porous body, a foam, and a nonwoven fabric may be used. In addition, an average thickness of the current collector may be appropriately applied in the range of 3 μm to 500 μm in consideration of the conductivity and total thickness of the positive electrode to be manufactured.

Method of Manufacturing Positive Electrode for Lithium Secondary Battery

A method of manufacturing a positive electrode for a lithium secondary battery according to one embodiment of the present technology includes a first mixture layer forming operation of forming a first mixture layer by applying a first slurry including a positive electrode active material and the positive electrode additive represented by Chemical Formula 1 below on one side or both sides of a current collector, a first rolling operation of rolling the formed first mixture layer, a second mixture layer forming operation of forming a second mixture layer by applying a second slurry including a positive electrode active material on the rolled first mixture layer, and a second rolling operation of rolling the formed second mixture layer, wherein the porosity of the first mixture layer ranges from 15% to 40%, and the porosity of the second mixture layer ranges from 40 to 70%.

LiₚCo_{(1-q)}M¹_{q}O₄ [Chemical Formula 1]

In Chemical Formula 1, M¹ denotes at least one element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and p and q are 5≤p≤7 and 0≤q≤0.5, respectively.

The method of manufacturing a positive electrode for a lithium secondary battery according to the present technology may improve excellent charging/discharging characteristics and lifetime characteristics of the lithium secondary battery by adding the positive electrode additive to the first mixture layer in contact with the current collector. In addition, by sequentially forming the second mixture layer on the first mixture layer so that the second mixture layer is located at the outermost portion, but controlling the conditions of the first and second rolling processes, there is an advantage of being capable of improving structures and electrical properties of the first and second mixture layers.

Further, in the method of manufacturing a positive electrode for a lithium secondary battery according to the present technology, the rolling of the first mixture layer is performed using a roll press before the formation of the second mixture layer and the rolling process is performed twice for performing secondary rolling, after the formation of the second mixture layer so that thickness uniformity of the first mixture layer can also be improved.

As an example, when a cross section of the positive electrode for a lithium secondary battery manufactured by the method of manufacturing a positive electrode for a lithium secondary battery is analyzed with a scanning electron microscope (SEM) in a thickness direction of the positive electrode, a condition of the following Equation 1 can be satisfied.

D²ₘᵢₙ/D¹ₘₐₓ×100≥70% [Equation 1]

In Equation 1, D¹ₘₐₓ denotes a maximum thickness of the first mixture layer after the first rolling operation, and D²ₘᵢₙ denotes a minimum thickness of the first mixture layer after the second rolling operation.

Equation 1 represents a rate of change in thickness according to the two rolling processes of the first mixture layer and means that, when the first rolling operation and the second rolling operation are performed and the cross section of the positive electrode is analyzed, as a ratio of the minimum thickness D²ₘᵢₙ of the first mixture layer after the second rolling operation to the maximum thickness D¹ₘₐₓ of the first mixture layer after the first rolling operation is higher, a thickness deviation of the first mixture layer is lower. Specifically, since the uniformity of the first mixture layer is remarkably high and thus a deviation between the minimum thickness D²ₘᵢₙ and the maximum thickness D¹ₘₐₓ is small, the condition of Equation 1 can be satisfied at 75% or more (e.g., D²ₘᵢₙ/D¹ₘₐₓ×100≥75%), at 80% or more (e.g., D²ₘᵢₙ/D¹ₘₐₓ×100≥80%), at 85% or more (e.g., D²ₘᵢₙ/D¹ₘₐₓ×100≥85%), at 90% or more (e.g., D²ₘᵢₙ/D¹ₘₐₓ×100≥90%), or ranging from 80 to 95% (e.g., 80%≤D²ₘᵢₙ/D¹ₘₐₓ×100≥95%).

First, in the present technology, the first mixture layer forming operation is performed at a temperature ranging from of 10° C. to 40° C. Specifically, the first mixture layer forming operation means that, when a first slurry is applied to the current collector, a temperature of the first slurry or a temperature of a reactor in which the first slurry is stored is controlled to a temperature ranging from 10° C. to 40° C. More specifically, in the first mixture layer forming operation, the temperature of the reactor in which the first slurry is stored may be controlled to a temperature ranging from 10° C. to 30° C., from 10° C. to 20° C., from 15° C. to 25° C., from 22° C. to 28° C., from 20° C. to 30° C., or from 18° C. to 25° C. When the temperature of the slurry is controlled to be less than a temperature of 10° C. in the first mixture layer forming operation, the slurry may not be uniformly applied on the current collector, and when the temperature is controlled to exceed a temperature of 40° C., degradation of the positive electrode additive contained in the first slurry may occur. Accordingly, in the first mixture layer forming operation, the temperature of the first slurry may be controlled in the above-described range.

In addition, in the first rolling operation, the thickness of the first mixture layer is uniformly maintained and a rolling density is increased so that, when the second mixture layer is rolled, it is possible to reduce an influence of the positive electrode active material on the uniformity of the interface. In addition, a rolling temperature is controlled in the first rolling operation, and thus it is possible to minimize the degradation of the positive electrode additive included in the first mixture layer. To this end, the first rolling operation may be performed at a high speed at a low temperature. Specifically, similar to the controlling of the temperature of the slurry when the above-described mixture layer is formed, the first rolling operation may be performed at a temperature ranging from 10° C. to 40° C., from 10° C. to 30° C., from 10° C. to 20° C., from 15° C. to 25° C., from 22° C. to 28° C., from 20° C. to 30° C., or from 18° C. to 25° C. In addition, the first rolling operation may be performed at a rolling speed ranging from 0.5 m/s to 6 m/s, and specifically, from 0.5 m/s to 5.5 m/s, from 0.5 m/s to 5 m/s, from 0.5 m/s to 4.5 m/s, from 0.5 m/s to 4 m/s, from 0.5 m/s to 3.5 m/s, from 0.7 m/s to 3 m/s, from 0.7 m/s to 2.5 m/s, from 0.7 m/s to 2 m/s, from 0.9 m/s to 2 m/s, from 1 m/s to 1.5 m/s, from 1 m/s to 1.2 m/s, from 2 m/s to 5 m/s, from 2 m/s to 5.5 m/s, or from 3 m/s to 5 m/s.

Next, like the first mixture layer forming operation, the second mixture layer forming operation may be performed at a temperature ranging from 10° C. to 40° C. As described above for the first mixture layer forming operation, the second mixture layer forming operation means that, when a second slurry is applied to the current collector, a temperature of the second slurry or a temperature of a reactor in which the second slurry is stored is controlled to a temperature ranging from 10° C. to 40° C. Since the positive electrode additive is not contained in the second slurry, the second mixture layer forming operation may be performed at a temperature that is higher than the temperature at which the first mixture layer is formed. However, when the temperature of the second slurry is high, since the positive electrode additive included in the first mixture layer may be directly affected, the temperature of the reactor in which the second slurry is stored may be controlled to a temperature ranging from 10° C. to 40° C.

In addition, when compared to the first rolling operation, the second rolling operation may be performed at a relatively high temperature and high speed. Specifically, the second rolling operation may be performed at a temperature ranging from 50° C. to 100° C., and more specifically, from 60° C. to 100° C., from 75° C. to 100° C., from 85° C. to 100° C., from 50° C. to 90° C., from 60° C. to 80° C., or from 65° C. to 90° C. Specifically, the second rolling operation may be performed at a rolling speed ranging from 2 m/s to 7 m/s, and more specifically, from 2 m/s to 6.5 m/s, from 2 m/s to 6 m/s, from 2 m/s to 5.5 m/s, from 2 m/s to 5 m/s, from 2 m/s to 4.5 m/s, from 2 m/s to 4 m/s, from 2.5 m/s to 4 m/s, from 2.5 m/s to 3.5 m/s, from 3.5 m/s to 5 m/s, from 5 m/s to 7 m/s, from 5.5 m/s to 6.5 m/s, or from 6 m/s to 7 m/s.

In addition, the first rolling operation and the second rolling operation may each be performed under a pressure condition ranging from 50 MPa to 200 MPa, and specifically, from 50 MPa to 150 MPa, from 50 MPa to 100 MPa, from 100 MPa to 200 MPa, from 150 MPa to 200 MPa, or from 80 MPa to 140 MPa. In this case, in order to optimize a rolling density of the first mixture layer, the first rolling operation may be performed under the same pressure condition as the second rolling operation or may be performed under a pressure condition that is two times or less a pressure condition of the second rolling operation, for example, that is 1.5 times or less, 1.2 times or less, or 1.1 to 1.4 times the pressure condition of the second rolling operation. In this way, a ratio (D1:D2) of an average thickness (D1) of the prepared first mixture layer to an average thickness (D2) of the prepared second mixture layer may range from 4:6 to 1:10. Specifically, the average thickness ratio (D1:D2) between the first and second positive electrode mixture layers may range from 3:7 to 1:10 or from 2:8 to 1:9. In the present technology, the thickness of the second negative electrode mixture layer is formed to be relatively thick so that a bonding force with the current collector is increased and stability of the electrode is increased.

According to the present technology, the first mixture layer and the second mixture layer are sequentially formed on the current collector under the above temperature condition and the above rolling conditions so that it is possible to manufacture a positive electrode containing a positive electrode additive with minimized degradation.

Lithium Secondary Battery

In one embodiment of the present technology, there is provided a lithium secondary battery including the above-described positive electrode according to the present technology, a negative electrode, and a separator interposed between the positive electrode and the negative electrode.

The lithium secondary battery according to the present technology may include the above-described positive electrode of the present technology, thereby reducing an amount of oxygen gas generated during charging and discharging as well as exhibiting excellent charging and discharging performance.

The lithium secondary battery of the present technology has a structure including the positive electrode, the negative electrode, and the separator interposed between the positive electrode and the negative electrode.

Here, the negative electrode is manufactured by applying, drying, and pressing the negative electrode active material on a negative electrode current collector and may further selectively include a conductive material as in the positive electrode, an organic binder polymer, an additive, as necessary.

In addition, the negative active material may include, for example, a carbon material and a silicon material. The carbon material means a carbon material containing carbon atoms as a main component. The carbon material may include one or more selected from the group consisting of graphite with a completely layered crystal structure as natural graphite, soft carbon with a low crystallinity layered crystal structure (a graphene structure is a structure in which hexagonal honeycomb planes of carbon are disposed in layers), hard carbon in which these structures are mixed with amorphous portions, artificial graphite, expanded graphite, carbon fiber, non-graphitized carbon, carbon black, acetylene black, Ketjen black, carbon nanotubes, fullerenes, activated carbon, graphene, and carbon nanotubes. More preferably, the carbon material may include natural graphite and/or artificial graphite and may include any one or more of graphene and carbon nanotubes together with the natural graphite and/or the artificial graphite. In this case, the carbon material may include graphene and/or carbon nanotubes at 0.1 to 10 parts by weight based on 100 parts by weight of the total carbon material, and more specifically, the carbon material may include graphene and/or carbon nanotubes at 0.1 to 5 parts by weight or 0.1 to 2 parts by weight based on 100 parts by weight of the total carbon material.

In addition, the silicon material is a particle including, as a main component, silicon (Si) as a metal component and may include one or more of Si particles and silicon oxide (SiO_{X} and 1≤X≤2) particles. As an example, the silicon material may include Si particles, silicon monoxide (SiO) particles, silicon dioxide (SiO₂) particles, or a mixture thereof.

In addition, the silicon material may have a mixed form of crystalline particles and amorphous particles, and a proportion of the amorphous particles is 50 to 100 parts by weight, specifically, 50 to 90 parts by weight, 60 to 80 parts by weight, or 85 to 100 parts by weight based on 100 parts by weight of the total silicon material. In the present technology, the proportion of the amorphous particles contained in the silicon material is controlled to the above range so that thermal stability and flexibility can be improved in a range that does not degrade electrical properties of the electrode.

In addition, the silicon material includes a carbon material and a silicon material and may be included of 1 to 20 parts by weight, and specifically, 5 to 20 parts by weight, 3 to 10 parts by weight, 8 to 15 parts by weight, 13 to 18 parts by weight, or 2 to 7 parts by weight based on 100 parts by weight of the negative electrode mixture layer.

In the present technology, the content of the carbon material and the silicon material included in the negative electrode active material is adjusted to the above ranges so that it is possible to improve a charging capacity per unit mass while reducing Li consumption and irreversible capacity loss during the initial charging and discharging of the battery.

As an example, the negative active material may include 95±2 parts by weight of graphite and 5±2 parts by weight of a mixture in which SiO particles and SiO₂ particles are uniformly mixed based on 100 parts by weight of the negative electrode mixture layer. In the present technology, the content of the carbon material and the silicon material included in the negative electrode active material is adjusted to the above ranges so that it is possible to improve a charging capacity per unit mass while reducing Li consumption and irreversible capacity loss during the initial charging and discharging of the battery.

In addition, the negative electrode mixture layer may have an average thickness ranging from 100 μm to 200, and specifically, from 100 μm to 180 μm, from 100 μm to 150 μm, from 120 μm to 200 μm, from 140 μm to 200 μm, or from 140 μm to 160 μm.

In addition, the negative electrode current collector is not particularly limited as long as it has high conductivity without causing a chemical change in the battery, and for example, copper, stainless steel, Ni, titanium, and calcined carbon may be used as the negative electrode current collector, and copper or stainless steel having a surface treated with carbon, nickel, titanium, or silver may be used. In addition, like the positive electrode current collector, fine irregularities may be formed on a surface of the negative electrode current collector to enhance a bonding force with the negative electrode active material, and a negative electrode current collector in various forms such as a film, a sheet, a foil, a net, a porous body, a foam, and a nonwoven fabric may be used. In addition, an average thickness of the negative electrode current collector may be appropriately applied in the range of 3 μm to 500 μm in consideration of the conductivity and total thickness of the negative electrode to be manufactured.

In addition, the separator is interposed between the positive electrode and the negative electrode, and an insulating thin film having high ion permeability and high mechanical strength is used as the separator. The separator is not particularly limited as long as it is generally used in the art, and specifically, chemical-resistant and hydrophobic polypropylene, a glass fiber, or a sheet or a nonwoven fabric made of polyethylene may be used as the separator. In some cases, a composite separator in which a porous polymer base material such as a sheet or nonwoven fabric is coated with inorganic particles/organic particles by an organic binder polymer may be used for the separator. When a solid electrolyte such as a polymer is used as the electrolyte, the solid electrolyte may also serve as the separator. In addition, the separator may have an average pore diameter ranging from 0.01 μm to 10 μm, and an average thickness ranging from 5 μm to 300 μm.

Meanwhile, the positive electrode and the negative electrode may be wound in the form of a jelly roll and accommodated in a cylindrical battery, a prismatic battery, or a pouch-type battery or may be accommodated in a pouch-type battery in a folding or stack-and-folding form, but the present technology is not limited thereto.

In addition, an electrolyte containing a lithium salt according to the present technology may consist of an electrolyte and a lithium salt, and a non-aqueous organic solvent, an organic solid electrolyte, or an inorganic solid electrolyte may be used as the electrolyte.

For example, as the non-aqueous organic solvent, an aprotic organic solvent such as N-methyl-2-pyrrolidinone, ethylene carbonate, propylene carbonate, butylene carbonate, dimethyl carbonate, diethyl carbonate, gamma-butyrolactone, 1,2-dimethoxy ethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxymethane, a dioxolane derivative, sulfolane, methyl sulfolane, 1,3-dimethyl-2-imidazolidinone, a propylene carbonate derivative, a tetrahydrofuran derivative, ether, methyl propionate, or ethyl propionate may be used.

For example, as the organic solid electrolyte, a polyethylene derivative, a polyethylene oxide derivative, a polypropylene oxide derivative, a phosphate ester polymer, poly agitation lysine, polyester sulfide, polyvinyl alcohol (PVA), polyvinylidene fluoride, or a polymer containing an ionic dissociation group may be used.

Nitrides, halides, sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, etc. may be used as the inorganic solid electrolyte.

The lithium salt is a material that is easily soluble in a non-aqueous electrolyte. For example, LiCl, LiBr, LiI, LiClO₄, LiBF₄, LiBioClio, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lithium lower aliphatic carboxylates, lithium tetraphenylboronate, or imide may be used as the lithium salt.

In addition, for the purpose of improving charging/discharging characteristics and flame retardancy, for example, pyridine, triethylphosphite, triethanolamine, cyclic ether, ethylene diamine, n-glyme, hexaphosphoric acid triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxyethanol, or aluminum trichloride may be added to the electrolyte. In some cases, in order to impart incombustibility, a halogen-containing solvent such as carbon tetrachloride or ethylene trifluoride may be further included, and in order to improve high-temperature storage characteristics, a carbon dioxide gas may be further included, and fluoro-ethylene carbonate (FEC) or propene sultone (PRS) may be further included.

Meanwhile, according to one embodiment of the present technology, a battery module including the above-described secondary battery as a unit cell is provided, and a battery pack including the battery module is provided.

The battery pack may be used as a power source for medium-large devices requiring high-temperature stability, long cycle characteristics, and high rate characteristics. Specific examples of the medium-large devices include power tools driven by an electric motor, electric vehicles (EVs) including EVs, hybrid EVs (HEVs), and plug-in HEVs (PHEVs), electric two-wheeled vehicles including electric bicycles (E-bikes) and electric scooters (E-scooters), electric golf carts, electric trucks, and systems for power storage, and more specifically, HEVs, but the present technology is not limited thereto.

Hereinafter, the present invention will be described in more detail with reference to examples and experimental examples.

However, the following examples and experimental examples are merely illustrative of the present invention, and the content of the present invention is not limited to the following examples and experimental examples.

### Examples 1 to 4 and Comparative Examples 1 to 7. Manufacture of Positive Electrode for Lithium Secondary Battery

95 parts by weight of LiNi_{0.8}Co_{0.1}Mn_{0.1}O₂ as a positive electrode active material, 0.9 parts by weight of Li₆CoO₄ as a positive electrode additive, 1.6 parts by weight of PVdF as a binder, and 2.5 parts by weight of carbon black as a conductive material were weighed and mixed with an N-methylpyrrolidone (NMP) solvent to prepare a first slurry for a first mixture layer.

Separately, 95 parts by weight of LiNi_{0.8}Co_{0.1}Mn_{0.1}O₂ as a positive electrode active material, 2 parts by weight of PVdF as a binder, and 3 parts by weight of carbon black as a conductive material were weighed and mixed with an NMP solvent to prepare a second slurry for a second mixture layer.

The first slurry was applied on aluminum foil and dried, and then the first rolling operation was performed to form a first mixture layer (an average thickness: 8 μm). Subsequently, the second slurry was applied on the first mixture layer and dried, and then the second rolling operation was performed to form a second mixture layer (an average thickness: 100 μm). In this case, by analyzing a cross section of the first mixture layer immediately after the first rolling operation and the second rolling operation were respectively performed, a maximum thickness D¹ₘₐₓ of the first mixture layer after the first rolling operation and a minimum thickness D²ₘᵢₙ of the first mixture layer after the second rolling operation were measured. A ratio of the measured result values (D²ₘᵢₙ/D¹ₘₐₓ) and the conditions for performing the first rolling operation and the second rolling operation are shown in Table 1 below. In addition, the conditions for performing the first and second mixture layer forming operations and the first and second rolling operations are shown in Table 1 below.

TABLE 1

| | First mixture | | | | Second | | | | |
|---|---|---|---|---|---|---|---|---|---|
| | layer | | | | mixture layer | | | | |
| | forming | | | | forming | | | | |
| | operation | | | | operation | Second rolling operation | | | |
| | Temperature | First rolling operation | | | Temperature of | Temper- | | | |
| | of first | Temperature | Pressure | Speed | second slurry | ature | Pressure | Speed | D²ₘᵢₙ/ |
| | slurry [° C.] | [° C.] | [MPa] | [m/s] | [° C.] | [° C.] | [MPa] | [m/s] | D¹ₘₐₓ |
| Example 1 | 30 ± 1 | 25 ± 1 | 100 | 1 | 30 ± 1 | 70 ± 1 | 100 | 3 | 0.94 |
| Example 2 | 30 ± 1 | 25 ± 1 | 100 | 1 | 30 ± 1 | 50 ± 1 | 100 | 3 | 0.85 |
| Example 3 | 30 ± 1 | 25 ± 1 | 100 | 1 | 30 ± 1 | 70 ± 1 | 100 | 3 | 0.93 |
| Example 4 | 30 ± 1 | 25 ± 1 | 100 | 4 | 30 ± 1 | 70 ± 1 | 100 | 4 | 0.92 |
| Comparative | 30 ± 1 | 25 ± 1 | 100 | 1 | 60 ± 1 | 25 ± 1 | 100 | 3 | 0.88 |
| Example 1 | | | | | | | | | |
| Comparative | 60 ± 1 | 25 ± 1 | 100 | 1 | 60 ± 1 | 25 ± 1 | 100 | 1 | 0.62 |
| Example 2 | | | | | | | | | |
| Comparative | 30 ± 1 | 25 ± 1 | 50 | 1 | 60 ± 1 | 70 ± 1 | 100 | 3 | 0.63 |
| Example 3 | | | | | | | | | |
| Comparative | 30 ± 1 | 60 ± 1 | 100 | 1 | 30 ± 1 | 70 ± 1 | 100 | 3 | 0.90 |
| Example 4 | | | | | | | | | |
| Comparative | 30 ± 1 | 25 ± 1 | 200 | 1 | 30 ± 1 | 70 ± 1 | 100 | 3 | 0.88 |
| Example 5 | | | | | | | | | |
| Comparative | 30 ± 1 | 25 ± 1 | 100 | 0.3 | 30 ± 1 | 70 ± 1 | 100 | 3 | 0.81 |
| Example 6 | | | | | | | | | |
| Comparative | 30 ± 1 | 25 ± 1 | 100 | 7 | 30 ± 1 | 70 ± 1 | 100 | 3 | 0.56 |
| Example 7 | | | | | | | | | |

### Experimental Example 1

1) Observation of XRD Pattern for First Mixture Layer

In order to confirm a change of the positive electrode additive according to a temperature when the positive electrode for a lithium secondary battery is manufactured, X-ray diffraction was measured for the first mixture layer of the positive electrode for a lithium secondary battery manufactured in Examples 1 to 4 and Comparative Examples 1 to 4, and a fraction included in each positive electrode additive was calculated from the measured X-ray diffraction. In this case, the X-ray diffraction was measured using an X-ray diffraction analyzer of Rigaku Corporation, and a wavelength of 1.5406 Å (Cu Ka radiation, 40 kV, and 100 mA) was scanned, and an X-ray diffraction pattern was obtained in the range of 15° to 64° at an angle of 2θ and at a scanning speed of 5°/sec.

As a result, peaks appearing in Li₆CoO₄ of the first mixture layers of Examples 1 to 4 were observed. Specifically, a peak A was observed in the range of 2θ=38.5±0.1°, and a peak B was observed in the range of 2θ=47.9±0.1°. For reference, A/B of Examples 1 to 4 was less than or equal to 0.1.

On the other hand, in Comparative Examples 1 to 4, the peaks shown in Examples 1 to 4 were not observed. It is considered that a structure of the positive electrode additive was deformed due to high temperatures in the mixture layer forming operation and the rolling operation when the positive electrode was manufactured.

### Experimental Example 2

In order to evaluate the performance of the positive electrode for a lithium secondary battery and the lithium secondary battery according to the present technology, the following experiment was performed.

1) Evaluation of Porosity of Positive Electrode

Electrode porosity for the first and second mixture layers of the positive electrode manufactured in the Examples and Comparative Examples was measured. In addition, the results are shown in Table 2 below.

2) Evaluation of Initial Resistance Value

A lithium secondary battery was manufactured using each positive electrode manufactured in the Examples and Comparative Examples. Specifically, natural graphite as a negative electrode active material, a carbon black conductive material, and a PVdF binder were mixed with an NMP solvent in a weight ratio of 85:10:5 to prepare a slurry for forming the negative electrode, and the slurry was applied to copper foil to manufacture a negative electrode. A separator (a thickness: about 16 μm) made of a porous polyethylene (PE) film was laminated and interposed between each positive electrode manufactured in the Examples and Comparative Examples and the manufactured negative electrode to manufacture an electrode assembly. The manufactured electrode assembly was placed inside a battery case, and then an electrolyte was injected into the case to manufacture a lithium secondary battery. In this case, the electrolyte was prepared by dissolving Li hexafluorophosphate (LiPF₆) at a concentration of 1.0 M in an organic solvent consisting of ethylene carbonate/dimethyl carbonate/ethyl methyl carbonate (a mixing volume ratio of EC/DMC/EMC is 3/4/3).

In addition, each of the manufactured lithium secondary batteries was charged with a constant current (CC) at a rate of 0.3 C using a CC-CV (constant voltage) method so that a voltage of the lithium secondary battery become 4.2 V at a current of 333 mA, and after the voltage of the battery reached 4.2V, the lithium secondary battery was charged once by cutting off a current at a rate of 0.05 C while maintaining a CV of 4.2V. One cycle of performing CC discharging was repeated three times for the one time-charged battery at a CC of 333 mA and at a rate of 0.3 C until the voltage of the battery reached 3 V. After recording a voltage drop that occurred when discharging was performed with a current of 2 A (2C) for ten seconds, a direct-current (DC) discharging resistance value was measured at the time of initial evaluation and calculated using R=V/1 (Ohm's law), which is shown in Table 2 below. In this case, DC resistance has a close relationship with output characteristics of the secondary battery.

3) Evaluation of Cycle Life Performance

In the same manner as in the evaluation of the initial resistance value, a lithium secondary battery was manufactured using each of the positive electrodes manufactured in the Examples and Comparative Examples. For each manufactured lithium secondary battery, a capacity retention rate was measured while performing 100 cycles of charging/discharging (n=100) and 200 cycles of charging/discharging (n=200) at a temperature of 25° C. under conditions of a final charging voltage of 4.25 V, a final discharging voltage of 2.5V, and 0.5 C/0.5 C. In this case, the capacity retention rate was calculated using Equation 2 below, and the results are shown in Table 2 below.

Capacity retention rate (%)=(discharging capacity at n cycles of charging and discharging/discharging capacity at one cycle of charging and discharging)×100 [Equation 2]

TABLE 2

| | | | | Capacity retention rate (%) during | |
|---|---|---|---|---|---|
| | Porosity (%) | | | charging/discharging | |
| | First mixture | Second mixture | Resistance | 100 cycles | 200 cycles |
| | layer | layer | (mΩ) | (n = 100) | (n = 200) |
| Example 1 | 30 | 49 | 64.8 | 98.1 | 94.9 |
| Example 2 | 25 | 50 | 63 | 98.5 | 95.6 |
| Example 3 | 28 | 55 | 63.9 | 96.9 | 94.7 |
| Example 4 | 28 | 50 | 61.2 | 98.7 | 95.7 |
| Comparative | 30 | 45 | 82.8 | 96.6 | 91.7 |
| Example 1 | | | | | |
| Comparative | 25 | 45 | 79.2 | 92 | 81.1 |
| Example 2 | | | | | |
| Comparative | 50 | 60 | 82.8 | 90.8 | 84.4 |
| Example 3 | | | | | |
| Comparative | 25 | 40 | 84.6 | 95.6 | 88.9 |
| Example 4 | | | | | |
| Comparative | 9 | 60 | 86.4 | 94.4 | 90.2 |
| Example 5 | | | | | |
| Comparative | 42 | 61 | 74.7 | 94.4 | 90.1 |
| Example 6 | | | | | |
| Comparative | 45 | 50 | 72 | 92 | 88.1 |
| Example 7 | | | | | |

As shown in Table 2, in the case of the lithium secondary batteries manufactured in the Examples, it was confirmed that the resistance values were lower than those of the Comparative Examples. In particular, the lithium secondary batteries including the positive electrodes of Comparative Examples 1 to 4 had highest resistance values. This is considered to be due to structural deformation of the positive electrode additive due to high temperatures in the mixture layer forming operation and the rolling operation when the positive electrodes of the Comparative Examples were manufactured. In addition, it was found that a battery having a positive electrode of the Examples had improved electrical performance and had a high capacity retention rate of 97% or more and 95% or more, respectively, when 100 cycles and 200 cycles of charging and discharging were performed.

On the other hand, in the case of Comparative Example 5, it was confirmed that the porosity of the first mixture layer was too small and thus it was difficult for the electrolyte to penetrate to the surface of the current collector so that the electrical performance of the battery was degraded. In addition, it was confirmed that, in each of the batteries having the positive electrodes of Comparative Examples 6 and 7, the porosity of the first mixture layer was significantly reduced so that the electrical performance of the batteries was degraded.

From the above results, the method of manufacturing a positive electrode for a lithium secondary battery according to the present technology can have excellent charging/discharging characteristics and improve lifetime characteristics of the lithium secondary battery by adding the positive electrode additive to the first mixture layer in contact with the current collector. In addition, by sequentially forming the second mixture layer on the first mixture layer so that the second mixture layer is located at the outermost portion and controlling conditions of the first and second rolling processes, it is possible to minimize the degradation of the positive electrode additive included in the first mixture layer, and thus it is possible to realize high battery performance.

Although the description has been made with reference to exemplary embodiments of the present invention, it should be understood that various alterations and modifications of the present invention can be devised by those skilled in the art to which the present invention pertains without departing from the spirit and scope of the present invention, which are defined by the appended claims.

Therefore, the technical scope of the present invention should not be limited to the contents described in the detailed description of this specification but should be determined by the scope of the appended claims.

1. A positive electrode for a lithium secondary battery, comprising:
a current collector; and
a mixture layer formed on one surface or both surfaces of the current collector,
wherein the mixture layer is a double-layer structure in which a first mixture layer and a second mixture layer are stacked,
wherein the first mixture layer includes a positive electrode active material, a positive electrode additive represented by Chemical Formula 1 below, a conductive material, and a binder, and
wherein a porosity of the first mixture layer ranges from 15% to 40%, and a porosity of the second mixture layer ranges from 40% to 70%:
LiₚCo_{(1-q)}M¹_{q}O₄, [Chemical Formula 1]
in Chemical Formula 1, M¹ denotes one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and p and q are 5≤p≤7 and 0≤q≤0.5, respectively.

2. The positive electrode of claim 1, wherein:
an average thickness of the first mixture layer ranges from 0.1 μm to 20 μm; and
an average thickness of the second mixture layer ranges from 50 μm to 300 μm.

3. The positive electrode of claim 1, wherein a ratio (D1:D2) of an average thickness (D1) of the first mixture layer to an average thickness (D2) of the second mixture layer ranges from 4:6 to 1:10.

4. The positive electrode of claim 1, wherein a content of the positive electrode additive ranges from 0.1 to 5 wt % based on a total weight of the first mixture layer.

5. The positive electrode of claim 1, wherein the positive electrode active material is a lithium metal composite oxide represented by Chemical Formula 2 below:
Liₓ[Ni_{y}Co_{z}Mn_{w}M²ᵥ]Oᵤ, [Chemical Formula 2]
in Chemical Formula 2, M² denotes one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and x, y, z, w, v, and u are 1.0≤x≤1.30, 0.1≤y<0.95, 0.01<z≤0.5, 0.01<w≤0.5, 0≤v≤0.2, and 1.5≤u≤4.5, respectively.

6. A method of manufacturing a positive electrode for a lithium secondary battery, the method comprising:
forming a first mixture layer in a first mixture layer forming operation by applying a first slurry including a positive electrode active material and a positive electrode additive represented by Chemical Formula 1 below on one side or both sides of a current collector;
rolling the formed first mixture layer in a first rolling operation;
forming a second mixture layer in a second mixture layer forming operation by applying a second slurry including a positive electrode active material on the rolled first mixture layer; and
rolling the formed second mixture layer in a second rolling operation,
wherein a porosity of the first mixture layer ranges from 15 to 40%, and a porosity of the second mixture layer ranges from 40 to 70%:
[Chemical Formula 1]
LiₚCo_{(1-q)}M¹_{q}O₄,
in Chemical Formula 1, M¹ denotes one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and p and q are 5≤p≤7 and 0≤q≤0.5, respectively.

7. The method of claim 6, wherein:
the first rolling operation is performed at a speed ranging from 0.5 m/s to 6 m/s;
the second rolling operation is performed at a speed ranging from 2 m/s to 7 m/s; and
the second rolling operation is performed at a faster speed than the first rolling operation.

8. The method of claim 6, wherein:
the first rolling operation is performed at a temperature ranging from 10° C. to 40° C.; and
the second rolling operation is performed at a temperature ranging from 40° C. to 100° C.

9. The method of claim 6, wherein the first mixture layer satisfies a thickness change rate condition of Equation 1 below:
D²ₘᵢₙ/D¹ₘₐₓ×100≥70%, [Equation 1]
in Equation 1, D¹ₘₐₓ denotes a maximum thickness of the first mixture layer after the first rolling operation, and D²ₘᵢₙ denotes a minimum thickness of the first mixture layer after the second rolling operation.

10. A lithium secondary battery comprising:
the positive electrode according to claim 1;
a negative electrode; and
a separator interposed between the positive electrode and the negative electrode.

11. The lithium secondary battery of claim 10, wherein:
the negative electrode includes a negative electrode current collector and a negative electrode mixture layer which is located on the negative electrode current collector and contains a negative electrode active material; and
the negative electrode active material includes a carbon material and a silicon material.
